(19) United States
(12) Patent Application Publication
(10) Pub. No.: US 2009/0139542 A1
(43) Pub. Date: Jun. 4, 2009

(54) APPARATUS AND METHOD FOR MANUFACTURING SEMICONDUCTOR DEVICE

(76) Inventor: Sinichi FURUKAWA, Kanagawa-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/323,294

(22) Filed: Nov. 25, 2008

(30) Foreign Application Priority Data
Nov. 27, 2007 (JP) 2007-306387

(51) Int. Cl. B08B 3/12; B08B 13/00; B08B 7/00

(52) U.S. Cl. 134/1.3; 134/56 R; 134/18; 382/149

(57) ABSTRACT

An apparatus for manufacturing a semiconductor device, includes: an application section configured to apply a force to a defect present on a surface of a substrate; a defect inspector configured to detect a position of the defect; a position comparator configured to compare the position of the defect between a plurality of results of the detection; and a defect remover configured to remove the defect from the substrate on basis of the results of the detection.

### CROSS-REFERENCE TO RELATED APPLICATIONS

This application is based upon and claims the benefit of priority from the prior Japanese Patent Application No. 2007-306387, filed on Nov. 27, 2007; the entire contents of which are incorporated herein by reference.

### BACKGROUND OF THE INVENTION

1. Field of the Invention

This invention relates to an apparatus and a method for manufacturing a semiconductor device.

2. Background Art

The process for manufacturing a semiconductor device conventionally includes the step of cleaning a wafer and the step of cleaning a chip to remove dust and the like attached to the wafer and the chip. Irregularities that cannot be removed by the cleaning step are detected in the inspection step and identified as defects (see, e.g., JP-A 11-094763 (1999)). Wafers and chips including many defects are discarded as nonconforming products. Thus, occurrence of defects is a major factor in the decreased yield of semiconductor devices.

However, in practice, it is difficult to remove all dust in the cleaning step. For example, during the cleaning step, the dust that has once detached from a wafer or a chip may often reattach to the wafer or the chip. Furthermore, addition of the step of cleaning the wafer and the chip to completely remove the dust requires dedicated facilities and complicated operations in the cleaning step, and hence results in increasing the manufacturing cost of semiconductor devices.

### SUMMARY OF THE INVENTION

According to an aspect of the invention, there is provided an apparatus for manufacturing a semiconductor device, including: an application section configured to apply a force to a defect present on a surface of a substrate; a defect inspector configured to detect a position of the defect; a position comparator configured to compare the position of the defect between a plurality of results of the detection; and a defect remover configured to remove the defect from the substrate on basis of the results of the detection.

According to another aspect of the invention, there is provided a method for manufacturing a semiconductor device, including: a first inspection step configured to detect the position of a defect present on a surface of a substrate; an application step configured to apply a force to the defect after the first inspection step; a second inspection step configured to detect a position of the defect after the force is applied thereto; a comparison step configured to compare the position of the defect between the first inspection step and the second inspection step; and a removal step configured to remove at least part of the defects that have changed in position between the first inspection step and the second inspection step.

According to still another aspect of the invention, there is provided a method for manufacturing a semiconductor device, including: applying a force to a defect present on a surface of a substrate while capturing a video image of the defect; detecting whether the defect has changed in position upon the application of the force; and removing at least part of the defects that have changed in position.

### BRIEF DESCRIPTION OF THE DRAWINGS

FIG. 1 illustrates an apparatus for manufacturing a semiconductor device according to a first embodiment of the invention;

FIG. 2 is a flow chart illustrating the method for manufacturing a semiconductor device according to the first embodiment;

FIGS. 3A to 3F illustrate the steps in the method for manufacturing a semiconductor device according to this embodiment;

FIG. 4 is a perspective view illustrating a manufacturing apparatus according to a first example;

FIG. 5 is a perspective view illustrating a manufacturing apparatus according to a second example;

FIG. 6 is a perspective view illustrating a manufacturing apparatus according to a third example;

FIG. 7 is a perspective view illustrating a manufacturing apparatus according to a fourth example;

FIG. 8 is a perspective view illustrating a manufacturing apparatus according to a fifth example;

FIG. 9 is a perspective view illustrating a manufacturing apparatus according to a sixth example;

FIG. 10 is a perspective view illustrating a manufacturing apparatus according to a seventh example;

FIG. 11 is a perspective view illustrating a manufacturing apparatus according to an eighth example;

FIG. 12A illustrates a manufacturing method according to a ninth example, and FIG. 12B is a graph illustrating the result of dust analysis in this example;

FIG. 13 illustrates an apparatus for manufacturing a semiconductor device according to a second embodiment of the invention;

FIG. 14 is a flow chart illustrating the method for manufacturing a semiconductor device according to the second embodiment;

FIG. 15 illustrates an apparatus for manufacturing a semiconductor device according to a third embodiment of the invention;

FIG. 16 illustrates an apparatus for manufacturing a semiconductor device according to a fourth embodiment of the invention; and

FIG. 17A is a top view illustrating a wafer, FIG. 17B illustrates a CAD data of a region R shown in FIG. 17A, and FIG. 17C is a top view illustrating the inspection result for the region R shown in FIG. 17A.

### DETAILED DESCRIPTION OF THE INVENTION

Embodiments of the invention will now be described with reference to the drawings, beginning with a first embodiment of the invention.

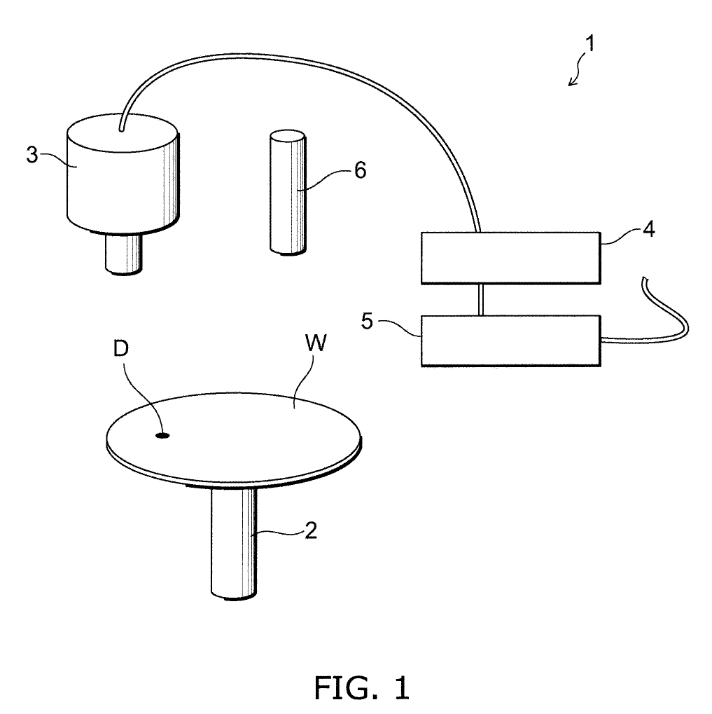

FIG. 1 illustrates an apparatus for manufacturing a semiconductor device according to this embodiment.

As shown in FIG. 1, the semiconductor device manufacturing apparatus 1 according to this embodiment is illustratively an apparatus for processing a wafer W serving as a substrate of a semiconductor device. The wafer W is illustratively a single crystal silicon wafer. It is assumed that a defect D is present on the surface of the wafer W. In the following description, cleaning of a wafer is taken as an example. However, this embodiment is also applicable to a chip. The same also applies to the other embodiments described later.

The manufacturing apparatus 1 according to this embodiment includes an application section 2 for applying a force to the defect D. The application section 2 may or may not double as a holder for the wafer W. The apparatus 1 further includes a defect inspector 3 for inspecting the surface of the wafer W to detect the position of the defect D. The defect inspector 3 is illustratively a CCD (charge-coupled device) camera for imaging the surface of the wafer W.

The apparatus 1 further includes a position memory 4 for storing position information of the defect D detected by the defect inspector 3. The position memory 4 is illustratively a memory device such as an HDD (hard disk drive). The apparatus 1 further includes a position comparator 5 for comparing the position of the defect D between a plurality of detection results obtained by the defect inspector 3. The position comparator 5 is illustratively a CPU (central processing unit) operated by a program. The position memory 4 and the position comparator 5 can be configured as a single personal computer.

The apparatus 1 further includes a defect remover 6 for removing the defect D from the wafer W. For example, the defect remover 6 sucks the defect D by drawing in air near the defect D or flicks the defect D off by ejecting gas or liquid at the defect D so as to individually remove the defect D on the basis of the position information of the defect D stored in the position memory 4. For example, the defect remover 6 includes a nozzle, a pump for sucking or ejecting air through the nozzle, and a driving means for positioning the tip of the nozzle near the defect D.

Next, a description is given of the operation of the apparatus for manufacturing a semiconductor device according to this embodiment configured as above, that is, a method for manufacturing a semiconductor device according to this embodiment.

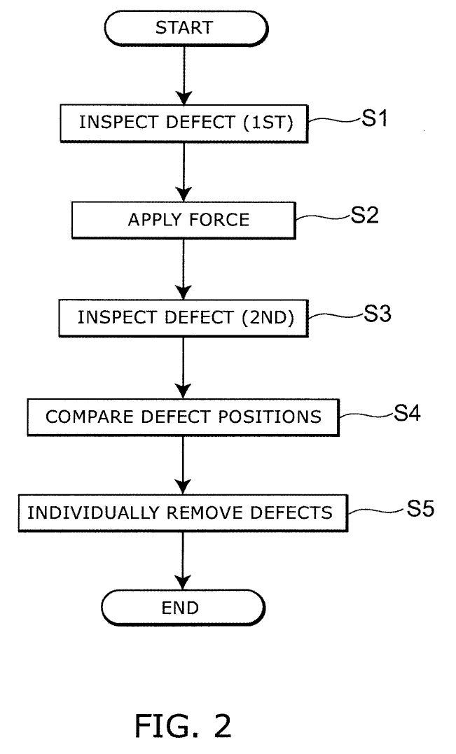

FIG. 2 is a flow chart illustrating the method for manufacturing a semiconductor device according to this embodiment.

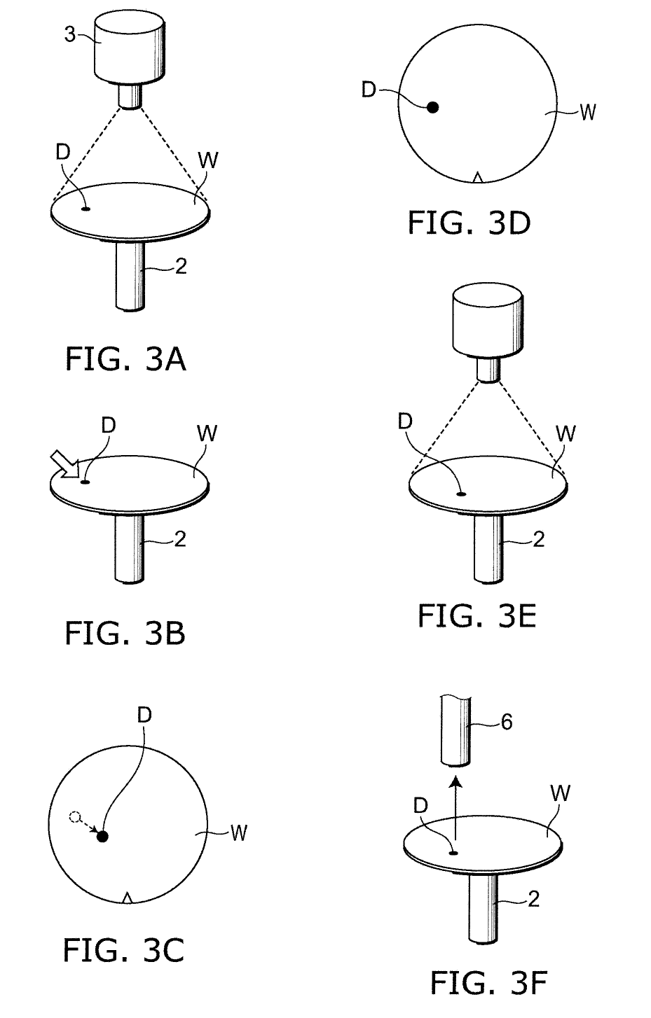

FIGS. 3A to 3F illustrate the steps in the method for manufacturing a semiconductor device according to this embodiment, in which FIG. 3A shows the first inspection step, FIG. 3B shows the first inspection result, FIG. 3C shows the step of applying a force, FIG. 3D shows the second inspection step, FIG. 3E shows the second inspection result, and FIG. 3F shows the removal step.

First, as shown in FIG. 2, step S1 and FIG. 3A, with the wafer W held by the application section 2, the defect inspector 3 inspects the surface of the wafer W. For example, the CCD camera of the defect inspector 3 images the wafer W and captures an image as shown in FIG. 3B. Thus, the position of a defect D is detected, and the position memory 4 stores the position information of this defect D. Here, the position information of a defect D is illustratively a numerical value representing the coordinate of the defect D on the wafer W.

Next, as shown in FIG. 2, step S2 and FIG. 3C, the application section 2 applies a force to the defect D. Here, the application of a force is preferably performed without bringing solid and liquid into contact with the surface of the wafer W. If the defect D is a substantially unremovable defect integrated or tightly coupled with the wafer W (hereinafter referred to as “fixed defect”), such as a protrusion or depression of the wafer W, a missing interconnect, and dirt stuck to the wafer W, then the defect D does not move even under application of the force. On the other hand, if the defect D is a defect that is simply put on or loosely coupled with the wafer W (hereinafter referred to as “floating defect”), such as dust, then the defect D moves on the wafer W upon application of the force.

Next, as shown in FIG. 2, step S3 and FIG. 3D, the defect inspector 3 inspects again the surface of the wafer W. Thus, an image as shown in FIG. 3E is captured. Then, the position memory 4 stores the position information of the defect D.

Next, as shown in FIG. 2, step S4, the position comparator 5 reads the position information of the defect D stored in the position memory 4 and compares the position of the defect D between the first inspection step (step S1) and the second inspection step (step S3). Thus, the position comparator 5 compares the positions of the defect D before and after the application of the force. The defect D that has changed in position upon the application of the force is determined as a floating defect. On the other hand, the defect D that has not changed in position upon the application of the force is determined as a fixed defect.

Next, as shown in FIG. 2, step S5 and FIG. 3F, the defect remover 6 removes at least part, illustratively all, of the floating defects, that is, the defects D that have changed in position upon the application of the force. For example, the driving means (not shown) of the defect remover 6 positions the tip of the nozzle near the defect D on the basis of the position information of the defect D stored in the position memory 4. Then, the pump (not shown) is actuated to suck the defect D by drawing in air from the tip of the nozzle or flick the defect D off by ejecting gas or liquid from the tip of the nozzle. Thus, the defect D is removed.

In the following, the effect of this embodiment is described.

In the conventional inspection method, defects present on the surface of a wafer W are not distinguished into fixed defects, which are substantially unremovable, and floating defects, which are removable. Hence, even wafers with only floating defects such as dust are all determined as nonconforming, and discarded. In contrast, in this embodiment, a force is applied to the defect D, and the positions of the defect D before and after the application are compared. Thus, defects present on the surface of the wafer W are distinguished into fixed defects and floating defects, and the floating defects, if any, are individually removed. Hence, the wafer with only floating defects can be made conforming, and the yield can be improved.

Furthermore, this embodiment does not use the conventional cleaning step. Hence, there is no need for facilities and complicated operations required for cleaning, and the manufacturing cost of semiconductor devices can be prevented from increasing. Thus, this embodiment can realize an apparatus and a method for manufacturing a semiconductor device with high yield and low manufacturing cost. Furthermore, the wafer is not subjected to damage associated with cleaning. In particular, application of a force to the defect D without bringing solid and liquid into contact with the surface of the wafer W ensures that the surface of the wafer W avoids damage.

Furthermore, the operation according to this embodiment can be placed between any steps in the process for manufacturing a semiconductor device. Hence, it is possible to examine which step involves the occurrence of much dust. Consequently, the step involving the occurrence of much dust can be identified, and countermeasures can be taken.

In the following, examples of this embodiment are described.

The first to eighth examples described below are examples of the method for applying a force to the defect.

The method for applying a force to the defect can illustratively be a method of applying a mechanical force or a method of applying an electromagnetic force. The method of applying a mechanical force can be a method of transmitting a force to the defect through the wafer or a method of transmitting a force to the defect through the ambient atmosphere. The method of applying an electromagnetic force can be a method of using an electric force or a method of using a magnetic force. In the following, examples of the methods are described.

To begin with, a first example is described.

This is an example of applying a mechanical force to the defect through the wafer.

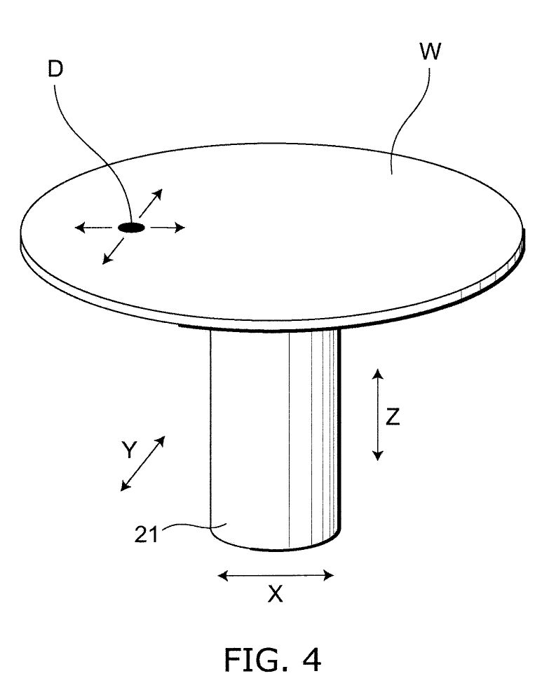

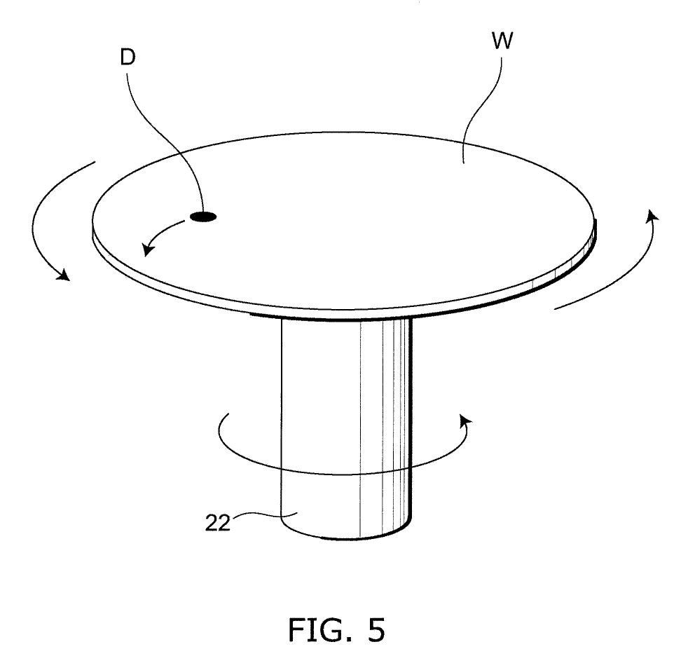

FIG. 4 is a perspective view illustrating a manufacturing apparatus according to this example.

As shown in FIG. 4, in this example, the application section 21 holds the wafer W and vibrates. The vibration can be performed in one direction (X direction) parallel to the surface of the wafer W, in two directions (XY directions) parallel to the surface of the wafer W and orthogonal to each other, in the perpendicular direction (Z direction) from the application section 21 toward the wafer W, or in both the above two directions and the perpendicular direction (XYZ directions). According to this example, the vibration of the application section 21 can vibrate the wafer W and apply a force to the defect D through the wafer W. Furthermore, according to this example, a force can be applied to the defect D without bringing solid and liquid into contact with the surface of the wafer W. Hence, there is no danger of damage to the wafer W.

Next, a second example is described.

This is also an example of applying a mechanical force to the defect through the wafer.

FIG. 5 is a perspective view illustrating a manufacturing apparatus according to this example.

As shown in FIG. 5, in this example, the application section 22 doubles as a holder for the wafer W and rotates. This rotation is spinning, and the rotation axis agrees with the central axis of the wafer W. According to this example, the rotation of the application section 22 can rotate the wafer W and apply a centrifugal force to the defect D. This example is also free from bringing solid and liquid into contact with the surface of the wafer W. Hence, there is no danger of damage to the wafer W.

Next, a third example is described.

This is an example of vibrating the wafer with the surroundings of the wafer W filled with liquid L.

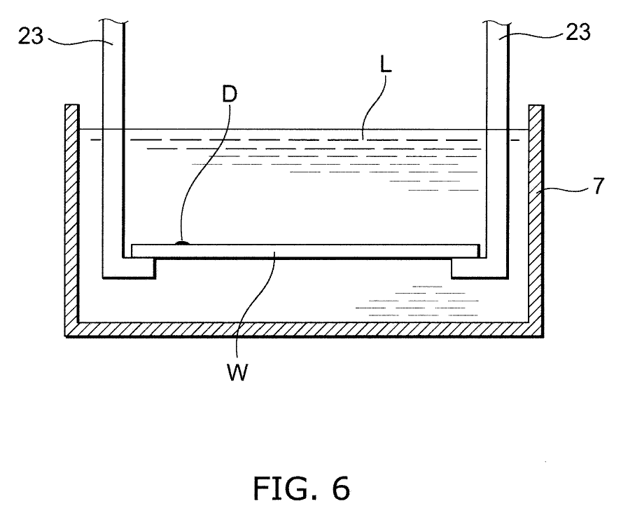

FIG. 6 is a cross-sectional view illustrating a manufacturing apparatus according to this example.

As shown in FIG. 6, this example includes a liquid retainer 7. The liquid retainer 7 is a container for retaining liquid L, large enough to accommodate the wafer W. This example further includes a pair of application sections 23 for suspending and holding the wafer W in the liquid retainer 7. The application sections 23 can vibrate.

In this example, with the liquid retainer 7 filled with liquid L such as DIW (deionized water), the wafer W is suspended by the pair of application sections 23 and held in the liquid L. Then, the wafer W is vibrated by the application sections 23. Thus, a force is applied to the defect D through the wafer W.

In this example, the atmosphere of the defect D is liquid. In general, the viscous modulus of a liquid is as high as approximately 100 times the viscous modulus of air. Hence, a reaction force from the surrounding liquid can be applied to the defect D. Furthermore, intrusion of the liquid between the wafer W and the defect D allows the defect D to float up from the wafer W, and the coefficient of friction between the wafer W and the defect D can be reduced. Thus, according to this example, although the surface of the wafer W needs to be in contact with liquid, the defect D can be effectively moved, and part of the immovable defects in the above first and second example can also be moved. It is noted that a gas having a higher viscous modulus than air, such as argon, can be used instead of liquid.

Next, a fourth example is described.

This is an example of applying a mechanical force to the defect through an air atmosphere.

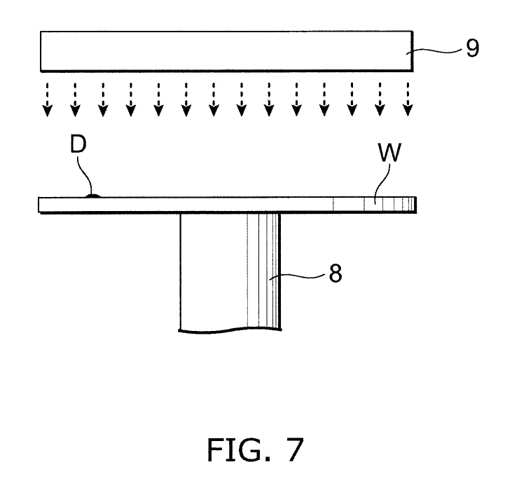

FIG. 7 is a side view illustrating a manufacturing apparatus according to this example.

As shown in FIG. 7, the manufacturing apparatus according to this example includes a holder 8 for holding the wafer W. The holder 8 simply holds the wafer W, and does not actively operate thereon. Furthermore, in this manufacturing apparatus, an acoustic wave generator 9 for generating a prescribed acoustic wave is located at a given distance away from the wafer W. According to this example, the acoustic wave generated by the acoustic wave generator 9 vibrates air around the wafer W, and this vibration is transmitted to the defect D. That is, a force is transmitted to the defect D through air. This is free from bringing solid and liquid into contact with the surface of the wafer W. Hence, there is no danger of damage to the wafer W. It is noted that application of an acoustic wave can be performed through a gas or liquid having a higher viscous modulus than air.

Next, a fifth example is described.

This is an example of applying a mechanical force to the defect through a gas atmosphere.

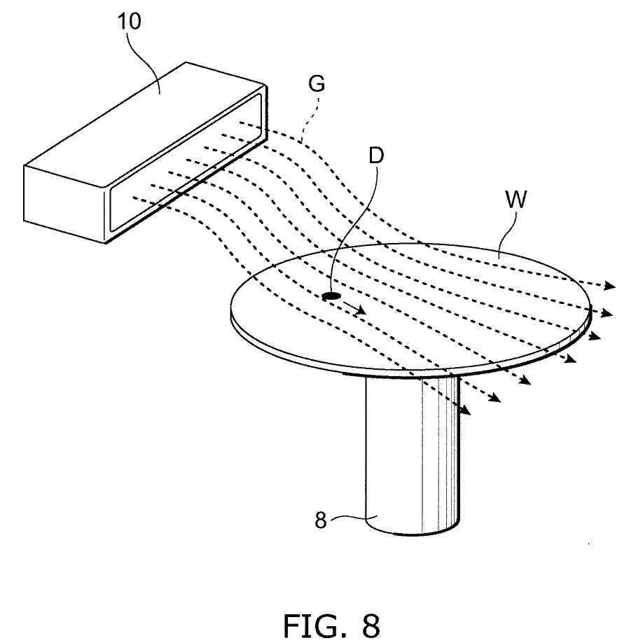

FIG. 8 is a perspective view illustrating a manufacturing apparatus according to this example.

As shown in FIG. 8, the manufacturing apparatus according to this example includes a holder 8 for holding the wafer W, and a gas ejector 10 for ejecting gas G at the wafer W. According to this example, the gas ejector 10 ejects gas G at the wafer W to apply a force to the defect D. The gas G ejected by the gas ejector 10 is a gas having a higher viscous modulus than air, such as argon. This example is also free from bringing solid and liquid into contact with the surface of the wafer W. It is noted that this example can be used in combination with the application of an acoustic wave described in the above fourth example.

Next, a sixth example is described.

This is an example of applying a mechanical force to the defect through a liquid atmosphere.

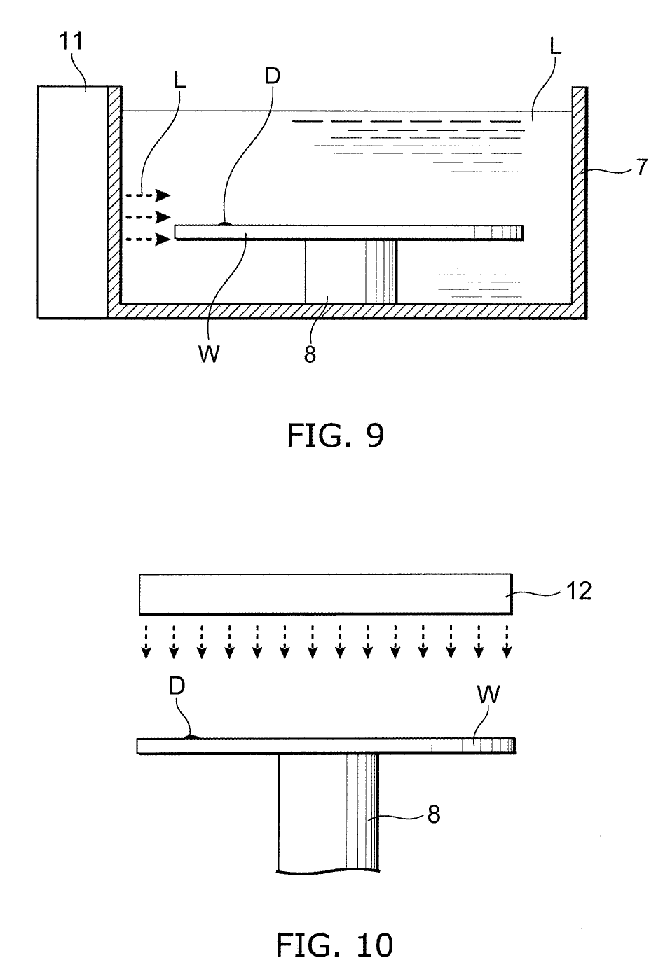

FIG. 9 is a cross-sectional view illustrating a manufacturing apparatus according to this example.

As shown in FIG. 9, the manufacturing apparatus according to this example includes a liquid retainer 7. As described above, the liquid retainer 7 is a container for retaining liquid L, large enough to accommodate the wafer W. Furthermore, a holder 8 is provided in the liquid retainer 7 and can hold the wafer W in the liquid L. Furthermore, a liquid ejector 11 is attached to the liquid retainer 7. The liquid ejector 11 ejects liquid L into the liquid retainer 7.

In this example, with the liquid L put in the liquid retainer 7 and the wafer W immersed in the liquid L, the liquid ejector 11 ejects liquid L at the surface of the wafer W. Thus, a force can be applied to the defect D through the liquid L. As described above, the viscous modulus of a liquid is approximately 100 times the viscous modulus of air. Hence, a larger force can be applied to the defect D than in the case of ejecting air. Furthermore, intrusion of the liquid between the defect D and the wafer W reduces the coefficient of friction between the defect D and the wafer W, and also has the effect of allowing the defect D to float up from the wafer W. Hence, the defect D can be moved more easily. Thus, according to this example, although the surface of the wafer W needs to be in contact with liquid, the defect D can be effectively moved, and part of the immovable defects in the above fourth and fifth example can also be moved. The liquid L is illustratively DIW. It is noted that this example can also be used in combination with the application of an acoustic wave.

Next, a seventh example is described.

This is an example of applying a force to the defect using an electric force.

FIG. 10 is a side view illustrating a manufacturing apparatus according to this example.

As shown in FIG. 10, in the manufacturing apparatus according to this example, the wafer W is held by a holder 8, and an electric charge generator 12 for generating positive or negative charge is provided at the frontside of the wafer W. The electric charge generator 12 can illustratively be an apparatus for generating static electricity, or an apparatus for exposing the wafer W to charged particles. According to this example, the charged defect D electrically adsorbed on the wafer W, which is not easily moved by a mechanical force such as vibration, can be effectively moved. Furthermore, in this example, a force can be applied to the defect D without bringing solid and liquid into contact with the surface of the wafer W.

Next, an eighth example is described.

This is an example of applying a force to the defect using a magnetic force.

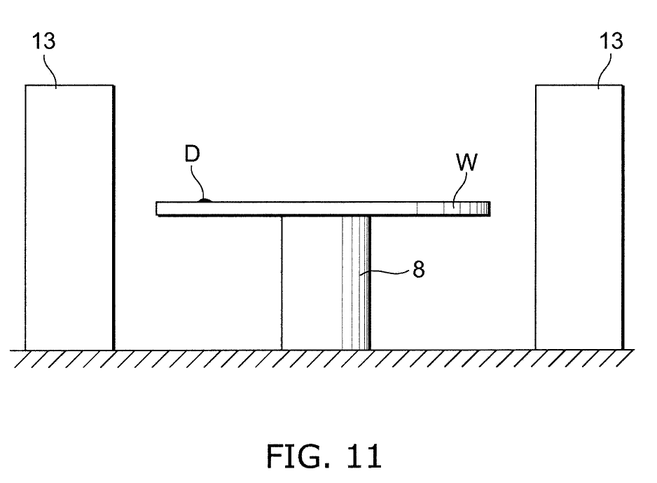

FIG. 11 is a side view illustrating a manufacturing apparatus according to this example.

As shown in FIG. 11, in the manufacturing apparatus according to this example, the wafer W is held by a holder 8, and a pair of electromagnets 13 are provided illustratively on both sides of the wafer W. Thus, a magnetic field can be generated at the position where the wafer W is placed. Furthermore, the magnetic flux density and the direction of the magnetic field can be varied by varying the current passed through the electromagnets 13. According to this example, in the case where the defect is made of a magnetic material such as iron, a force can be applied thereto by a magnetic force. Here, there is no need to bring solid and liquid into contact with the surface of the wafer W.

Next, a ninth example of this embodiment is described.

This is an example of applying the above first embodiment to dust analysis for each step in the process for manufacturing a semiconductor device.

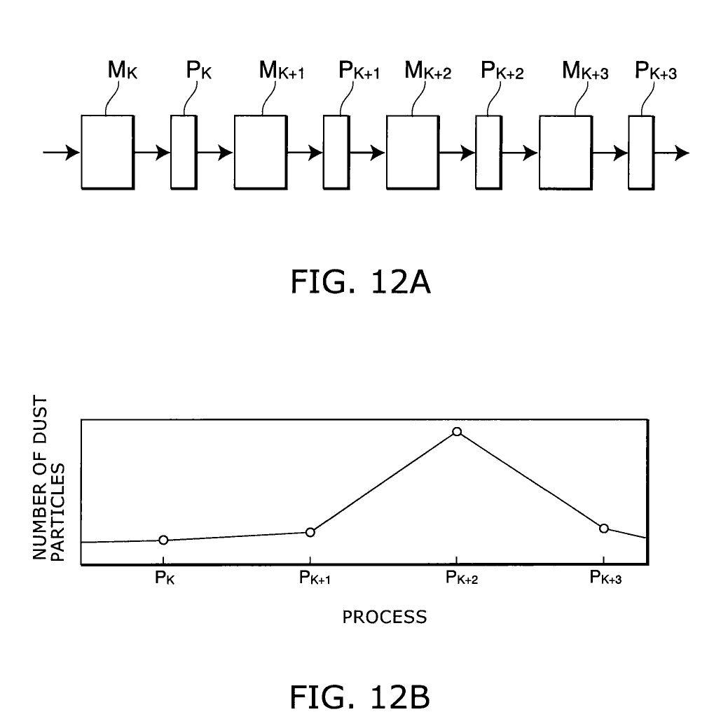

FIG. 12A illustrates a manufacturing method according to this example, and FIG. 12B is a graph illustrating the result of dust analysis in this example, where the horizontal axis represents the processes, and the vertical axis represents the number of dust particles.

As shown in FIG. 12A, in this example, the process P for performing the manufacturing method according to this embodiment, that is, the process P composed of steps S1 to S5 shown in FIG. 2, is inserted between sequential processes for manufacturing a semiconductor device. In the example shown in FIG. 12A, the processes Pₖ to Pₖ₊₃ of this embodiment are provided immediately after the sequential processes Mₖ to Mₖ₊₃ for manufacturing a semiconductor device, respectively. Thus, the number of floating defects detected in each process P is measured, and the measurement result is used as the number of dust particles. Here, the processes Mₖ to Mₖ₊₃ are fabrication processes for the wafer W, such as oxidation, nitride film formation, lithography, and etching processes.

As shown in FIG. 12B, if more dust particles are detected in the process Pₖ₊₂ than in the other processes P, it is inferred that a large amount of dust is generated in the immediately preceding process Mₖ₊₂. Thus, anti-dust measures can be taken intensively for the process Mₖ₊₂.

Next, a second embodiment of the invention is described.

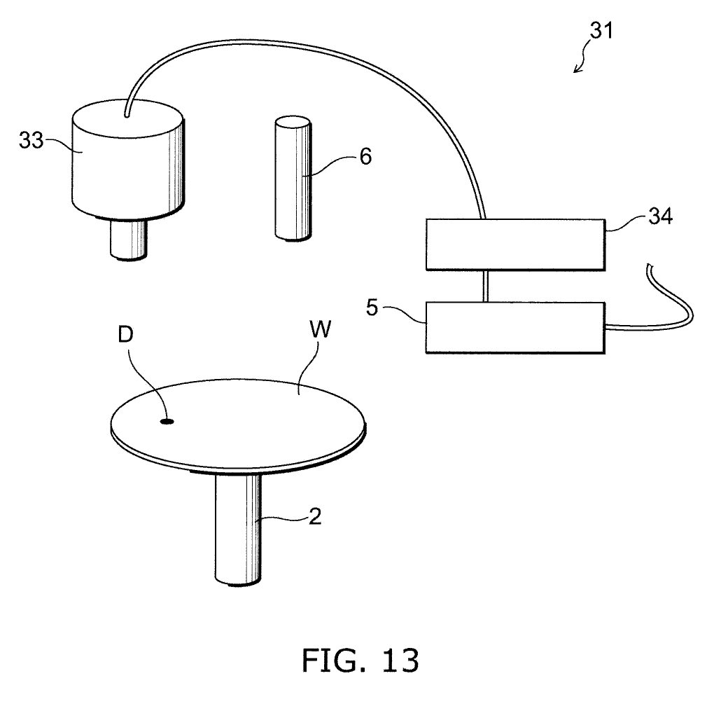

FIG. 13 illustrates an apparatus for manufacturing a semiconductor device according to this embodiment.

As shown in FIG. 13, the manufacturing apparatus 31 according to this embodiment is different from the manufacturing apparatus 1 according to the above first embodiment (see FIG. 1) in including a video capturer 33 instead of the defect inspector 3 (see FIG. 1). Furthermore, a video memory 34 is provided instead of the position memory 4 (see FIG. 1). The configuration in this embodiment other than the foregoing is the same as that in the above first embodiment.

Next, a description is given of the operation of the apparatus for manufacturing a semiconductor device according to this embodiment configured as above, that is, a method for manufacturing a semiconductor device according to this embodiment.

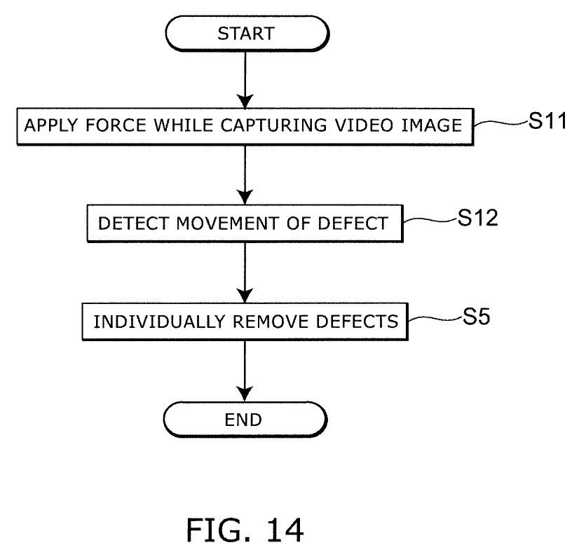

FIG. 14 is a flow chart illustrating the method for manufacturing a semiconductor device according to this embodiment.

First, as shown in step S11 of FIG. 14, with the wafer W held by the application section 2, the video capturer 33 starts to capture a video image of the surface of the wafer W, and the captured video image is stored in the video memory 34. While the video image is captured, the application section 2 applies a force to the defect D. The method by which the application section 2 applies a force to the defect D can illustratively be any of the methods described in the first to eighth example of the above first embodiment. Here, if the defect D is a fixed defect, the defect D is not moved. If the defect D is a floating defect, the defect D is moved on the wafer W. After the application section 2 stops applying the force, the video capturer 33 stops capturing the video image.

Next, as shown in step S12 of FIG. 14, on the basis of the video data stored in the video memory 34, the position comparator 5 detects whether the position of the defect D has changed. The defect D that has changed in position is determined as a floating defect, and the defect D that has not changed in position is determined as a fixed defect. Then, as shown in step S5 of FIG. 14, the defect remover 6 removes at least part of the floating defects. This removal method is the same as that in the above first embodiment.

According to this embodiment, when the wafer is inspected, a video image, rather than a static image, is captured. Thus, for example, when a floating defect has moved away from a position and another floating defect is moved and reattached to the position, this embodiment can avoid an erroneous determination that the defect is not moved. The effect in this embodiment other than the foregoing is the same as that in the above first embodiment.

Next, a third embodiment of the invention is described.

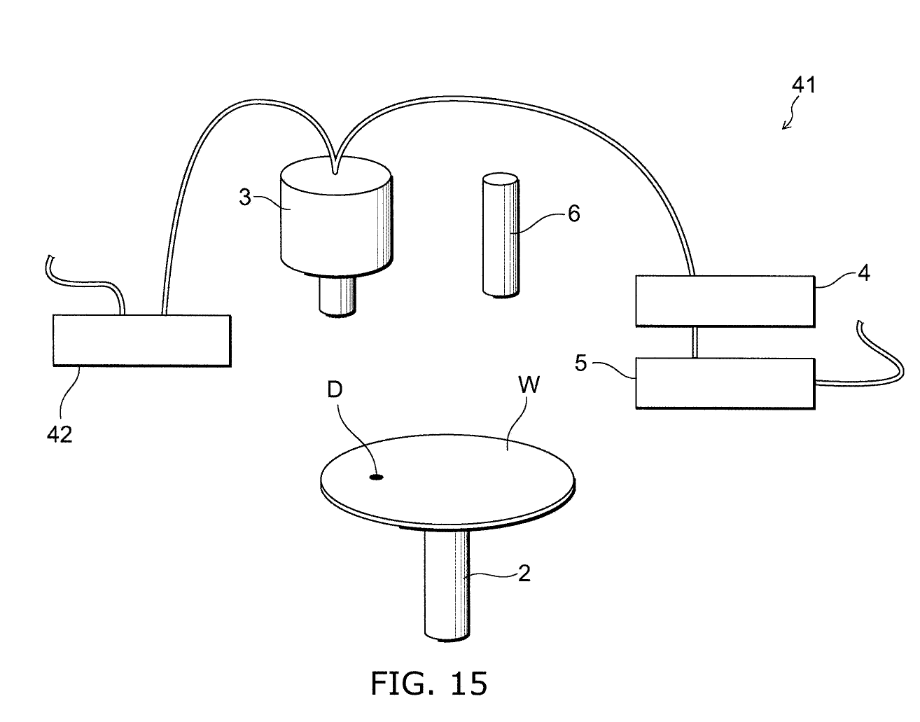

FIG. 15 illustrates an apparatus for manufacturing a semiconductor device according to this embodiment.

As shown in FIG. 15, in addition to the configuration of the manufacturing apparatus 1 according to the above first embodiment (see FIG. 1), the manufacturing apparatus 41 according to this embodiment includes a defect classifier 42 connected to the defect inspector 3. The defect classifier 42 analyzes the moving direction, moving distance and the like of defects on the basis of the inspection result obtained by the defect inspector 3 and classifies the defects using the analysis result. The moving direction and the moving distance of a defect depend on physical properties such as its shape and size as well as chemical properties such as its adsorptivity on the wafer. Hence, significant classification can be performed by statistically analyzing the moving direction and the moving distance and classifying the defects using the analysis result.

According to this embodiment, classification of defects allows a more accurate study to be made in search of the process generating the defect and its cause. For example, a new cause is suggested by detection of a large number of defects that are different in type from the previously detected defects. The configuration, operation, and effect in this embodiment other than the foregoing are the same as those in the above first embodiment. In this embodiment, like the above second embodiment, it is also possible to capture a video image rather than a static image. Then, the behavior of the moving defect can be analyzed in more detail.

Next, a fourth embodiment of the invention is described.

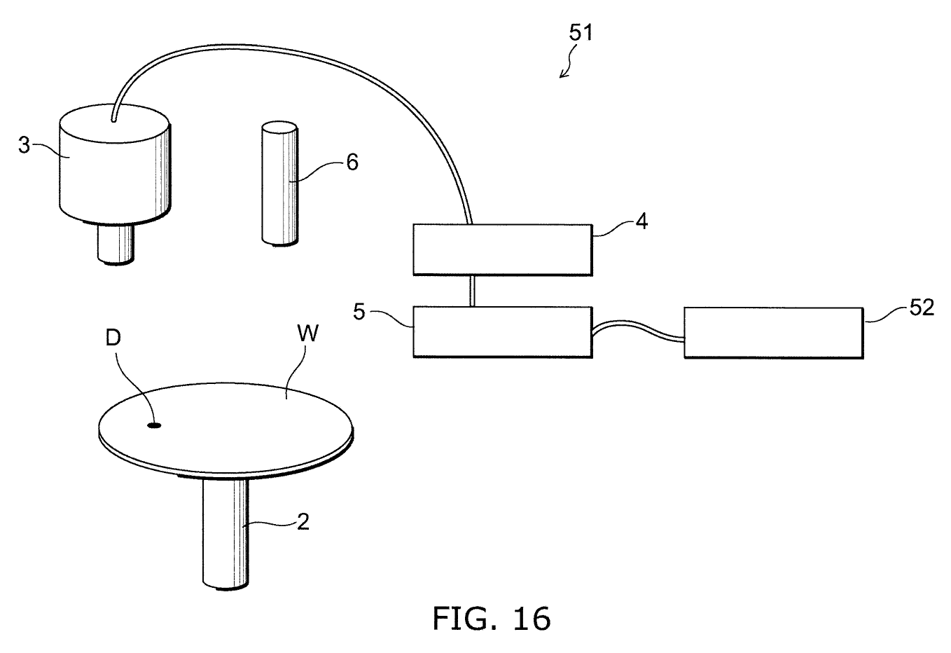

FIG. 16 illustrates an apparatus for manufacturing a semiconductor device according to this embodiment.

As shown in FIG. 16, in addition to the configuration of the manufacturing apparatus 1 according to the above first embodiment (see FIG. 1), the manufacturing apparatus 51 according to this embodiment includes a database 52 connected to the position comparator 5. The database 52 is illustratively configured as a storage means such as an HDD. The database 52 stores the design data of integrated circuits to be formed on the surface of the wafer W, such as CAD (computer-aided design) data.

Next, the operation of the manufacturing apparatus according to this embodiment is described.

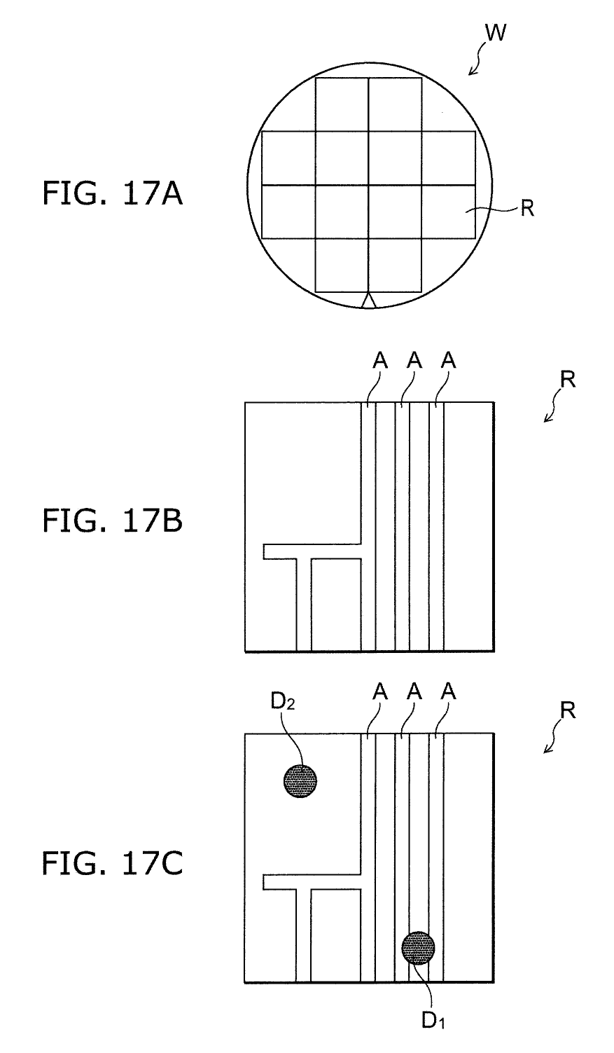

FIG. 17A is a top view illustrating a wafer, FIG. 17B illustrates a CAD data of a region R shown in FIG. 17A, and FIG. 17C is a top view illustrating the inspection result for the region R shown in FIG. 17A.

In this embodiment, the method shown in steps S1 to S4 of FIG. 2 is used to detect floating defects. It is assumed that as a result, floating defects have been detected in the region R of the wafer W shown in FIG. 17A. Next, as shown in FIGS. 16 and 17B, the CAD data of the region R where the floating defects are detected is read from the database 52. An interconnect A is indicated in this CAD data.

Next, as shown in FIG. 17C, the detection result of the floating defects is superimposed on the CAD data. Thus, the positional relationship between the floating defects and the interconnect A is ascertained. For example, as shown in FIG. 17C, it is assumed that the floating defect D₁ is located on the interconnect A, and that the floating defect D₂ is located away from the interconnect A. In this case, it can be determined that the floating defect D₁ needs to be removed because it may short-circuit the interconnect A, whereas the floating defect D₂ may be left unaddressed because it is not in contact with the interconnect A and is less likely to cause electrical trouble. Thus, it turns out that only the floating defect D₁ needs to be removed in the process of individually removing floating defects.

Thus, according to this embodiment, by comparing the detection result of floating defects with CAD data, the degree of harmfulness of floating defects can be evaluated, and the number of defects to be individually removed can be decreased. Consequently, redundant operations can be reduced, and the efficiency of the process can be improved. The configuration, operation, and effect in this embodiment other than the foregoing are the same as those in the above first embodiment.

The invention has been described with reference to the embodiments and examples. However, the invention is not limited to these embodiments and examples. Any suitable addition, deletion, or design change of components, or any addition, omission, and condition change of steps in the above embodiments and examples made by those skilled in the art are also encompassed within the scope of the invention as long as they fall within the spirit of the invention.

For example, the method for applying a force to a defect is not limited to the above methods. The method for individually removing a defect is not limited to suction or ejection described above, but, for example, it is also possible to use a method of adsorbing a defect using static electricity. In the above embodiments and examples, processing of a wafer is illustratively described. However, the invention is not limited thereto, but is applicable to any substrate. For example, the invention can be applied to diced chips. Furthermore, the above embodiments and examples can be practiced in combination with each other.

1. An apparatus for manufacturing a semiconductor device, comprising:
an application section configured to apply a force to a defect present on a surface of a substrate;
a defect inspector configured to detect a position of the defect;
a position comparator configured to compare the position of the defect between a plurality of results of the detection; and
a defect remover configured to remove the defect from the substrate on basis of the results of the detection.

2. The apparatus according to claim 1, wherein
the position comparator compares the positions of the defect before and after the application of the force, and
the defect remover removes at least part of the defects that have changed in position upon the application of the force.

3. A method for manufacturing a semiconductor device, comprising:
a first inspection step configured to detect a position of a defect present on a surface of a substrate;
an application step configured to apply a force to the defect after the first inspection step;
a second inspection step configured to detect the position of the defect after the force is applied thereto;
a comparison step configured to compare the position of the defect between the first inspection step and the second inspection step; and
a removal step configured to remove at least part of the defects that have changed in position between the first inspection step and the second inspection step.

4. The method according to claim 3, further comprising:
classifying the defects on basis of the change in position.

5. The method according to claim 3, further comprising:
selecting the defects to be removed, from among the defects that have changed in position, on basis of design data of an integrated circuit to be formed on the surface of the substrate.

6. The method according to claim 3, wherein the force is applied without bringing solid and liquid into contact with the surface of the substrate.

7. The method according to claim 3, wherein the force is applied by transmitting a mechanical force to the defect through the substrate.

8. The method according to claim 7, wherein the force is applied to the defect by vibrating the substrate.

9. The method according to claim 7, wherein the force is applied to the defect by rotating the substrate.

10. The method according to claim 3, wherein the force is applied by transmitting a mechanical force to the defect through an ambient atmosphere.

11. The method according to claim 10, wherein the force is applied to the defect by vibrating the substrate with the substrate held in a liquid.

12. The method according to claim 10, wherein the force is applied to the defect by generating an acoustic wave at a position located away from the substrate.

13. The method according to claim 10, wherein the force is applied to the defect by ejecting a gas at the substrate.

14. The method according to claim 10, wherein the force is applied to the defect by ejecting a liquid at the substrate.

15. The method according to claim 3, wherein the force is an electric force.

16. The method according to claim 3, wherein the force is a magnetic force.

17. A method for manufacturing a semiconductor device, comprising:
applying a force to a defect present on a surface of a substrate while capturing a video image of the defect;
detecting whether the defect has changed in position upon the application of the force; and
removing at least part of the defects that have changed in position.

18. The method according to claim 17, further comprising:
classifying the defects on basis of the change in position.

19. The method according to claim 17, further comprising:
selecting the defects to be removed, from among the defects that have changed in position, on basis of design data of an integrated circuit to be formed on the surface of the substrate.

20. The method according to claim 17, wherein the force is applied without bringing solid and liquid into contact with the surface of the substrate.
